(19) United States
(12) Patent Application Publication
(10) Pub. No.: US 2011/0010923 A1
(43) Pub. Date: Jan. 20, 2011

(54) METHOD OF MAKING AN APPLIANCE DOOR

(75) Inventors: JAMES CHARLES LESLIE GUARINO, Kalamazoo, MI (US); JAMES W. KENDALL, Mount Prospect, IL (US); ALAN S. LUCAS, Evansville, IN (US); VIKAS MALHOTRA, Evansville, IN (US); KEITH ALLEN SNYDER, Newburgh, IN (US); JOHN J. VONDERHAAR, Saint Joseph, MI (US)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/504,739

(22) Filed: Jul. 17, 2009

(51) Int. Cl. B23P 17/00

(52) U.S. Cl. 29/592

(57) ABSTRACT

A method of making an appliance door includes inserting a door pan into a fixture having first and second forming molds. An inner door liner is placed over the door pan. The first and second forming molds are pressed together. A mold cavity is formed between the door pan and the inner door liner. An insulative material is injected into the mold cavity defined by the space between the door pan and the inner door liner. The inner door liner is secured to the door pan to form a base door. A removable decorative exterior skin is extended over the base door.

### BACKGROUND OF THE PRESENT INVENTION

The present invention generally relates to a method of making an appliance door, and more specifically, to a method of making an appliance door that can be used on a variety of refrigerator constructions. New refrigerator designs are incorporating flexible design concepts allowing the consumer to select different features. Some of the features include, for example, module components. These and other modules operate using utilities in the form of electrical power, data signals, and fluids in either liquid or gaseous form, or the like.

### SUMMARY OF THE INVENTION

In one aspect of the present invention, a method of making an appliance door includes inserting a door pan into a fixture having first and second forming molds. An inner door liner is placed over the door pan. The first and second forming molds are pressed together. A mold cavity is formed between the door pan and the inner door liner. An insulative material is injected into the mold cavity defined by the space between the door pan and the inner door liner. The inner door liner is secured to the door pan to form a base door. A removable decorative exterior skin is extended over the base door.

In another aspect of the present invention, a method of making an appliance door includes inserting a film into a fixture having first and second forming molds. An inner door liner is placed over the film. The first and second forming molds are pressed together. A mold cavity is formed between the film and the inner door liner. An insulative material is injected into the mold cavity defined by the space between the film and the inner door liner. The inner door liner is secured with the frame to form a base door. A removable decorative exterior skin is extended over the base door.

In yet another aspect of the present invention, a method of making an appliance door includes inserting a support frame into a fixture having first and second forming molds. Utility lines are inserted into the fixture. The first and second forming molds are pressed together. An insulative material is injected between the first and second forming molds in contact with the support frame. The injected insulative material is set to form a base door. An inner door liner is secured over the base door. A removable decorative exterior skin is extended over the base door.

These and other features, advantages and objects of the present invention will be further understood and appreciated by those skilled in the art upon studying the following specification, claims, and appended drawings.

### BRIEF DESCRIPTION OF THE DRAWINGS

FIG. 1A is a side cross-sectional elevational view of a mold cavity prior to constructing a base door;

FIG. 1B is a side cross-sectional elevational view of a mold cavity during insertion of insulative material;

FIG. 1C is a side cross-sectional elevational view of a mold cavity after insulative material has been placed in the mold cavity;

FIG. 2 is a top front exploded perspective view of one embodiment of a door assembly;

FIG. 3 is a top rear exploded perspective view of the door assembly of FIG. 2;

FIG. 4 is a top front exploded perspective view of another embodiment of a door assembly;

FIG. 4A is an enlarged top perspective view of area IVA of FIG. 4;

FIG. 5 is a top rear exploded perspective view of the door assembly of FIG. 4;

FIG. 6 is a top front exploded perspective view of another embodiment of a door assembly;

FIG. 6A is an enlarged top perspective view of area VIA of FIG. 6;

FIG. 7 is a top rear exploded perspective view of the door assembly of FIG. 6;

FIG. 8 is a top front exploded perspective view of another embodiment of a door assembly;

FIG. 9 is a top rear exploded perspective view of the door assembly of FIG. 8;

FIG. 10 is a top front exploded perspective view of another embodiment of a door assembly;

FIG. 11 is a top rear exploded perspective view of the door assembly of FIG. 10;

FIG. 12 is a front elevational view of a completed door assembly;

FIG. 13 is a rear elevational view of the door assembly of FIG. 12;

FIG. 14 is a left side elevational view of the door assembly of FIG. 12;

FIG. 15 is a right side elevational view of the door assembly of FIG. 12;

FIG. 16 is a top elevational view of the door assembly of FIG. 12;

FIG. 17 is a bottom elevational view of the door assembly of FIG. 12;

FIG. 18 is a top perspective partially exploded view of a press fit door assembly;

FIG. 19 is a top perspective view of a press fit door assembly;

FIG. 20 is a top perspective partially exploded view of a door assembly with top and bottom end caps; and

FIG. 21 is a top perspective view of a door assembly with top and bottom end caps.

### DETAILED DESCRIPTION OF EMBODIMENTS

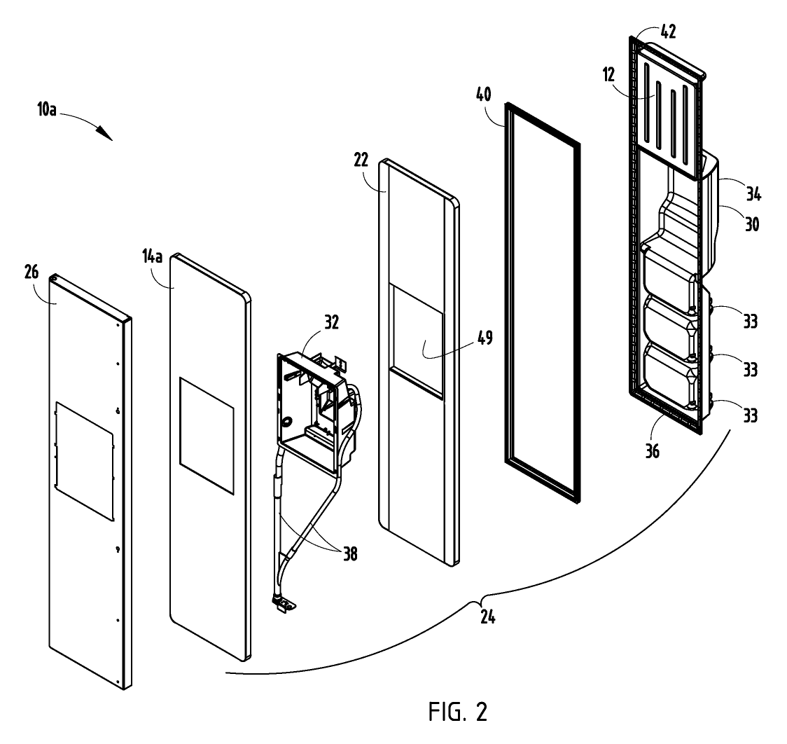

For purposes of description herein the terms “upper,” “lower,” “right,” “left,” “rear,” “front,” “vertical,” “horizontal,” and derivatives thereof shall relate to the invention as oriented in FIG. 2. However, it is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

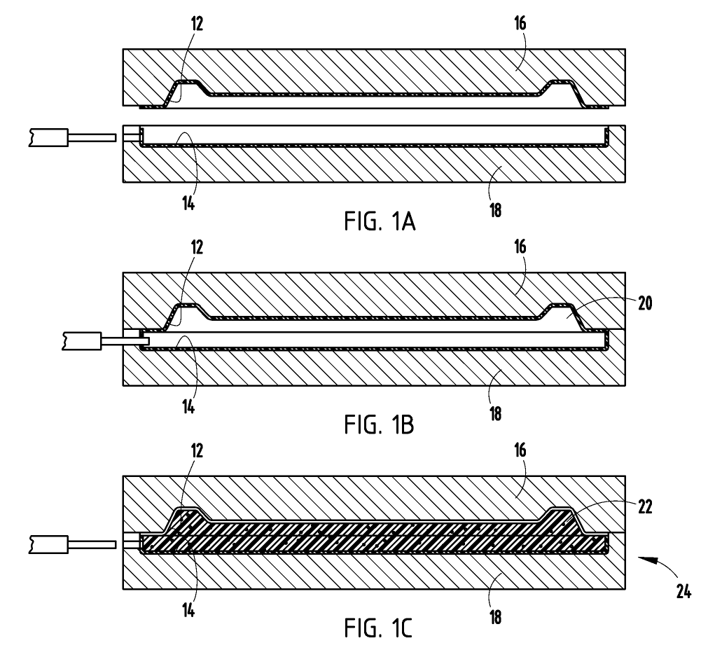

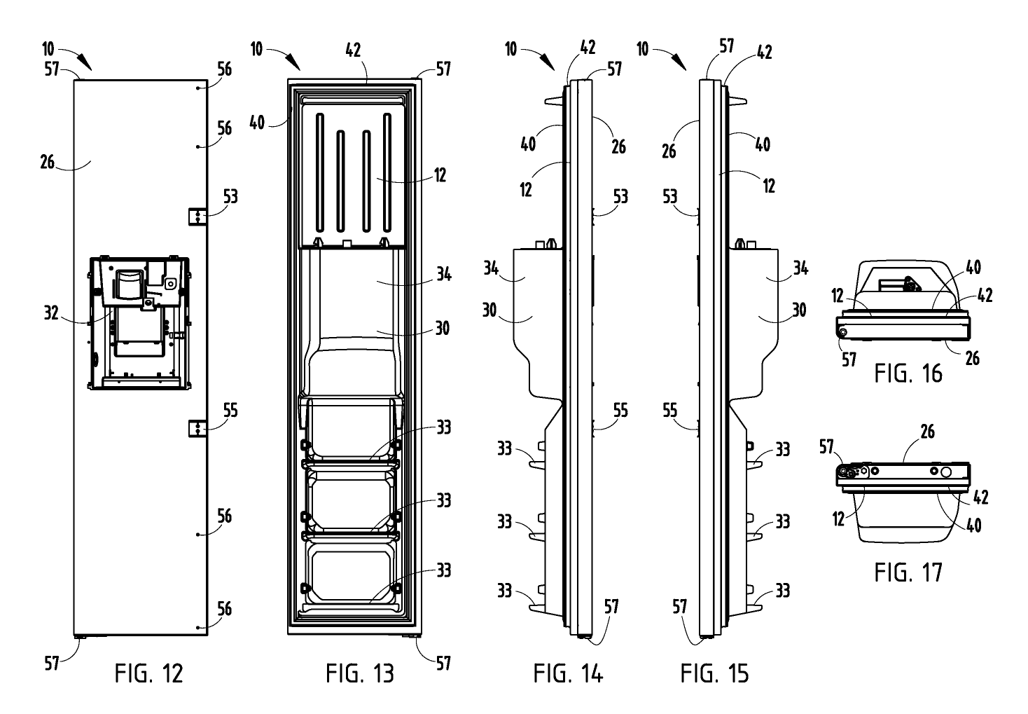

FIGS. 1A-1C generally illustrate a method of making an appliance door 10 (FIG. 12). An inner door liner 12 is placed over the door pan 14a. First and second forming molds 16, 18 of a fixture are pressed together. A cavity 20 is formed between the door pan 14a and the inner door liner 12. An insulative material 22 is injected into the cavity 20 defined by the space between the door pan 14a and the inner door liner 12. The inner door liner 12 is secured to the door pan 14a to form a base door 24 and a perimeter gasket 40 is affixed thereto. A decorative exterior skin 26 (FIG. 2) is extended over the base door 24.

The reference numeral 10 generally designates an appliance door and is intended to cover each variation of constructing a door as disclosed herein and equivalents thereof, including doors 10a, 10b, 10c, 10d, and 10e.

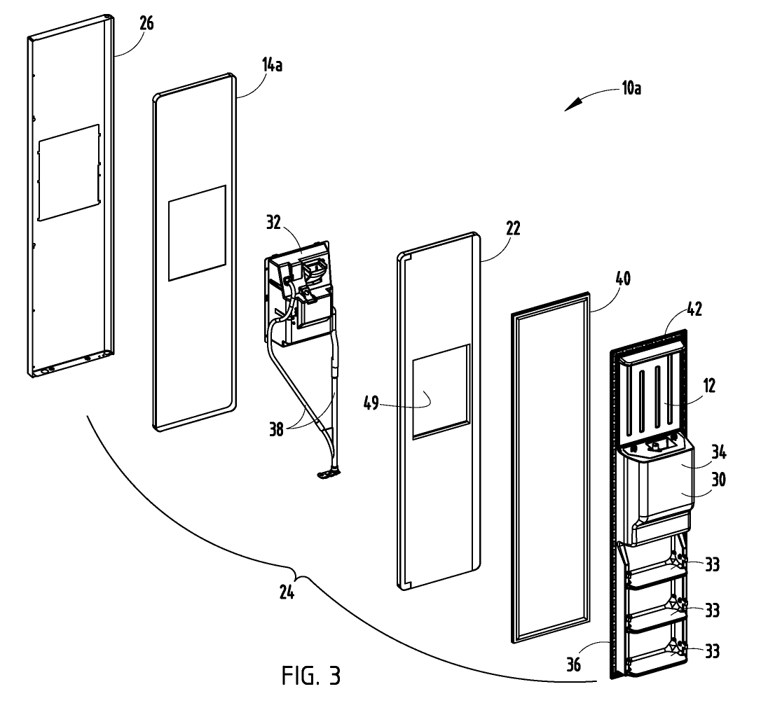

Referring now to FIGS. 2-3, the inner door liner 12 may include any of a number of configurations. The illustrated embodiment of FIGS. 2 and 3 includes a projection 30 in the inner door liner 12 for receiving a storage unit or module such as an ice machine 32. The projection 30 projects into an interior side 34 of the inner door liner 12, but opens to an exterior side 36 (FIG. 2). Multiple shelves 33 are disposed below the projection 30 and are adapted to support food goods or feature modules disposed thereon. It is contemplated that the inner door liner 12 is formed from any of a number of materials, including high impact polystyrene, ABS, and polyethylene. The ice machine 32 extends into the projection 30 in the inner door liner 12 and includes conduits 38 that are disposed between the insulative material 22 and the door pan 14a. Alternatively, the conduits 38 may extend into channels formed in the insulative material 22. The conduits 38 are designed to receive utility lines including electrical lines and water lines. A gasket 40 extends around a periphery of the inner door liner 12 and is held against a perimeter flange integral to the door pan 14a. The door pan 14a is adhesively bonded by the insulative material 22 to inner door liner 12 to form the base door 24. The decorative outer skin 26 is then secured over the base door 24 adjacent to the door pan 14a to form the appliance door 10a. The door pan 14a provides structural support to the appliance door 10a.

Referring again to FIGS. 2 and 3, an aperture 49 is made in the insulative material 22 during the foaming process or made after the insulative material 22 has set and hardened. The aperture 49 is designed to accommodate a wide variety of modules and devices and may be formed during door construction in a multitude of ways. Specifically, the aperture 49 may be cut out after the base door 24 is formed, or after the complete door 10 is constructed. Alternatively, the aperture 49 may be made using a block that creates a void in the door during the injection of foam material 22 into the cavity 20. The block is later removed to create the aperture 49. A decorative exterior skin 26 may then be assembled over the pan 14a to provide aesthetic variation for door 10a in terms of shape, color, finish, or material type.

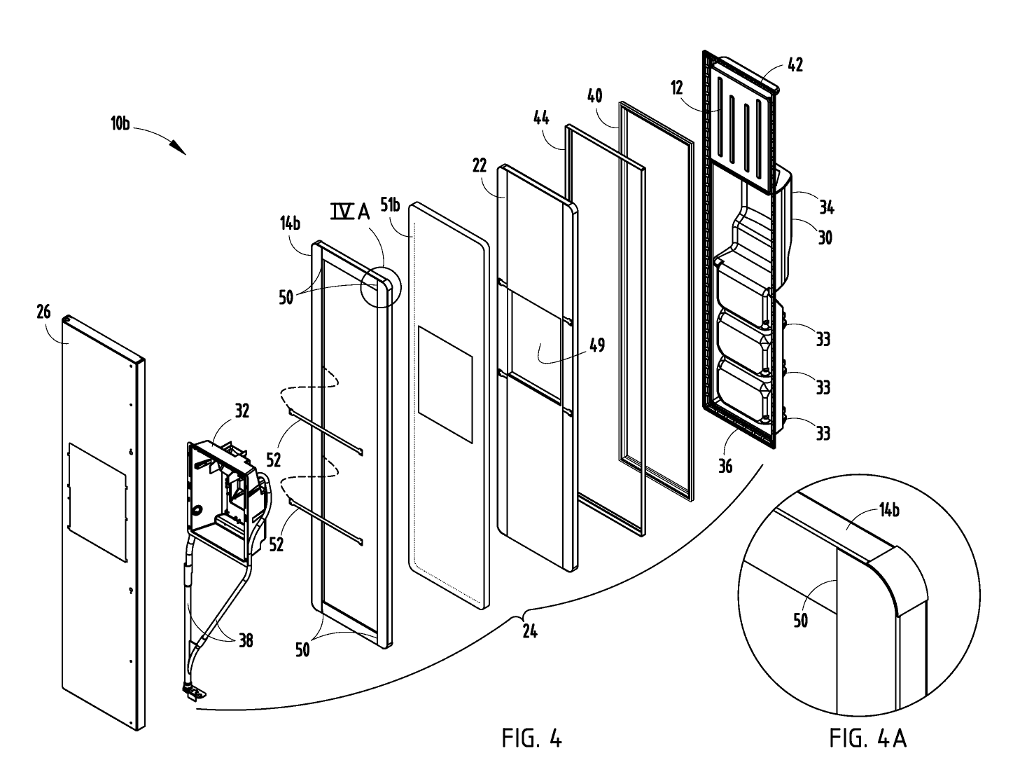

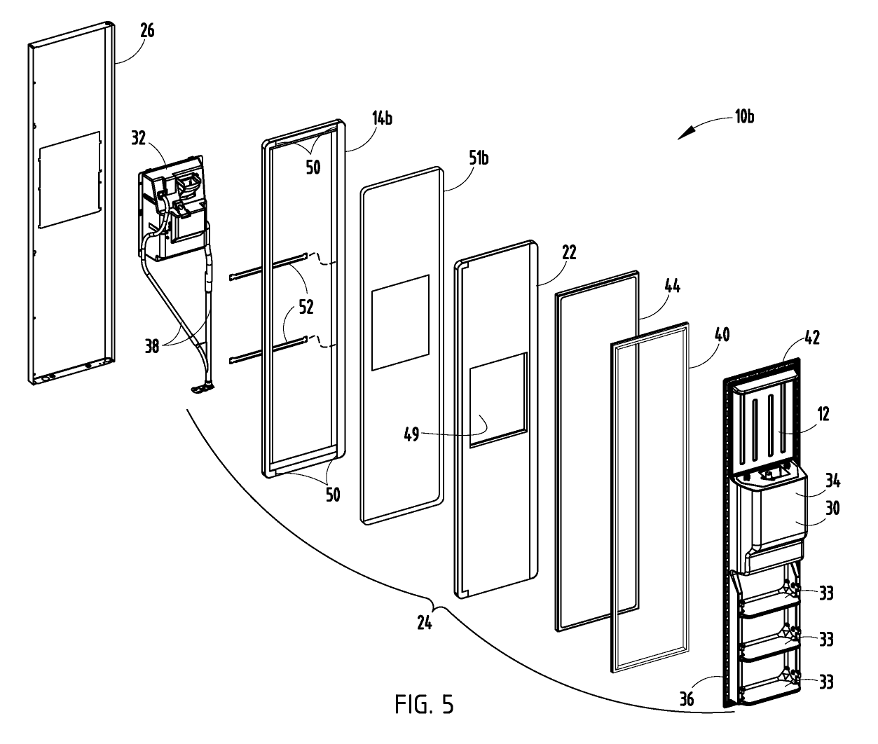

Referring now to the embodiment illustrated in FIGS. 4 and 5, another manner of assembling an appliance door 10b includes inserting the inner door liner 12 and gasket 40 in the first and second forming molds 16, 18 (FIGS. 1A-1C) which are subsequently pressed together. The insulative material 22, which is polyurethane or a similar material, is then inserted into the cavity 20 formed by the first and second forming molds 16, 18. A release agent or film 51b is placed against the mold surface of the second forming mold. The film 51b may be of polyethylene or similar material. The film 51b can also be used as a moisture barrier that inhibits moisture from entering the insulative material 22. A frame 14b having a tubular construction (FIGS. 4 and 5) is then placed in abutting contact with the insulative material 22, and the inner door liner 12 and gasket 40 are secured with the inner door liner 12 by the door flange 44. A component, such as the ice machine 32 is placed in the appliance door 10b in operable connection with the inner door liner 12 and is accessible from the outside of the appliance door 10b. The tubular outer frame 14b adds rigidity to the appliance door 10b and is fastened or welded at each corner 50, as shown in FIG. 4A. Cross members 52 are positioned at predetermined points in the frame 14b, to add additional strength, as needed. The cross members 52 may be welded or mechanically fastened to the frame 14b at positions that do not interfere with components that may be installed in the door 10b. If the film 51b or release agent is present on both sides of the insulative material 22, the inner door liner 12 may be secured to the frame 14b by mechanical fasteners.

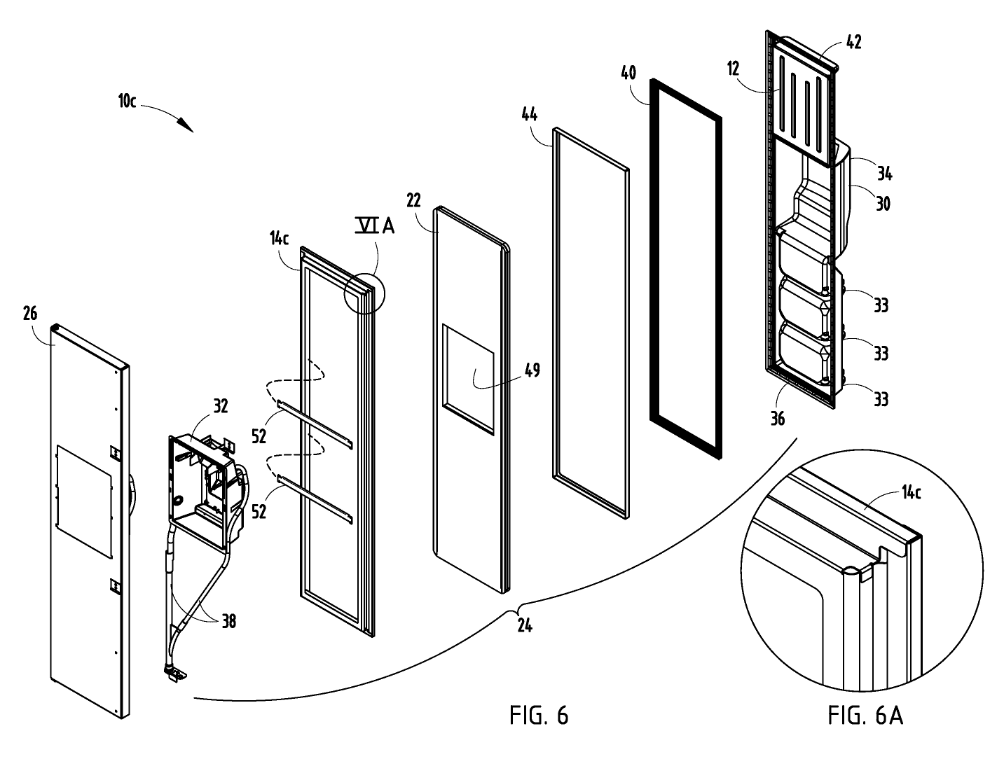

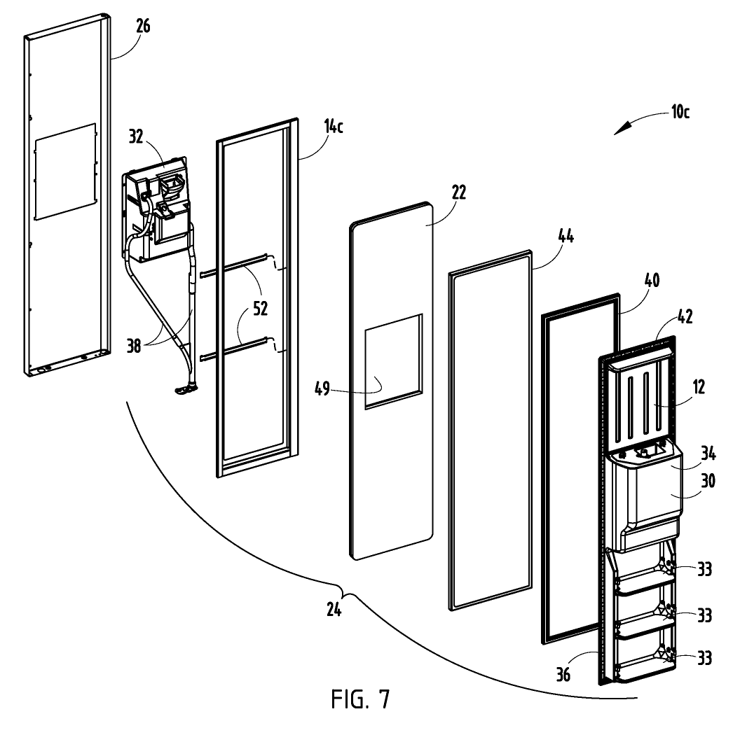

Alternatively, as shown in the embodiment illustrated in FIGS. 6 and 7, an appliance door 10c may use a stair-step frame 14c having a three-dimensional stair-step design instead of the tubular construction of frame 14b. The stair-step frame 14c is formed from a single metal blank and stamped or folded on a break press, for example, then cut and bent into typically a rectangular shape and the adjoining ends fastened mechanically or by tack weld to provide a unitary frame 14c (FIG. 6A). It is contemplated that the stair-step design could have a variety of constructions with varying dimensions, depending on the required rigidity, weight, and versatility desired.

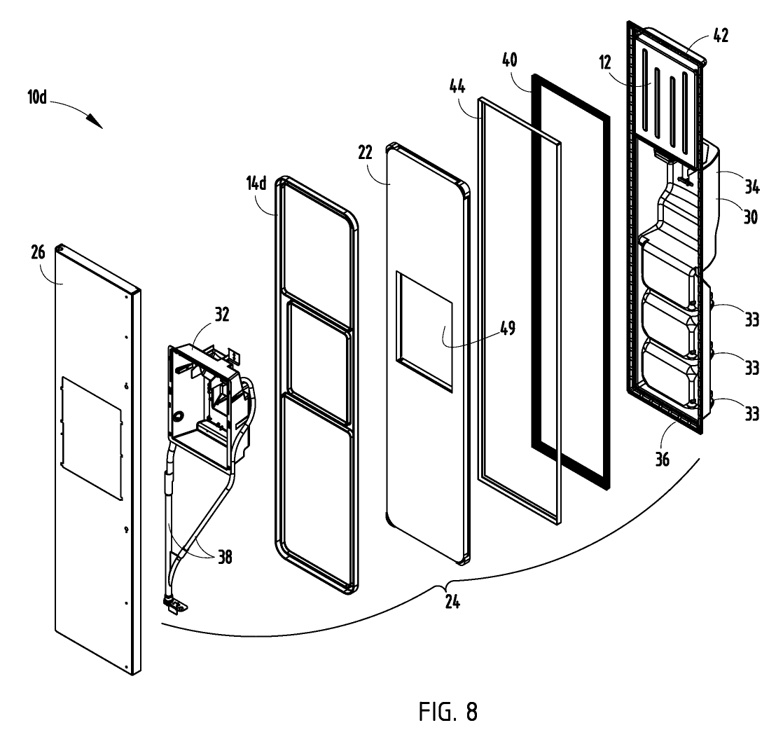

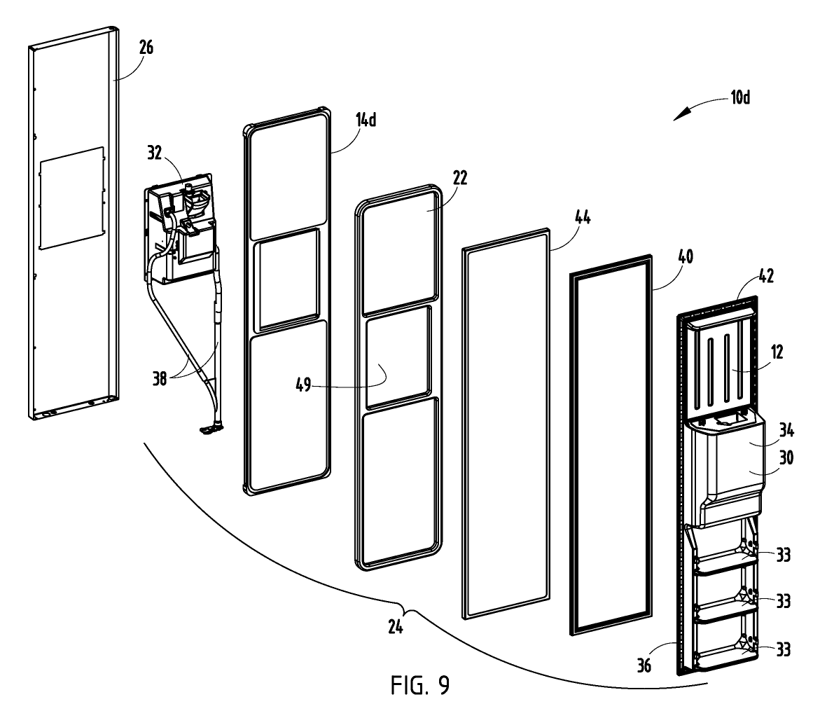

Referring now to the embodiment illustrated in FIGS. 8 and 9, yet another manner of assembling the appliance door 10d includes inserting a frame 14d into the mold cavity 20. The frame 14d may include molded plastic, metal, or other material, and may be in various forms, including H-beam, I-beam, U-channel, or other configurations. In addition, the frame 14d may include utility lines 38 and mounting hardware adapted to connect with components that may exist in the appliance door 10d. The frame 14d is either encased in or bonded to the insulative material 22 in the mold cavity 20. After the insulative material 22 cures around the frame 14d and is connected or bonded to the inner door liner 12 and gasket 40, a component, such as the ice machine 32 shown is installed in the frame 14d and connected with utility lines 38 to form the base door 24. A decorative exterior skin 26 may then be assembled over the base door 24 to provide aesthetic variation in shape, color, finish, or type of material for door 10d.

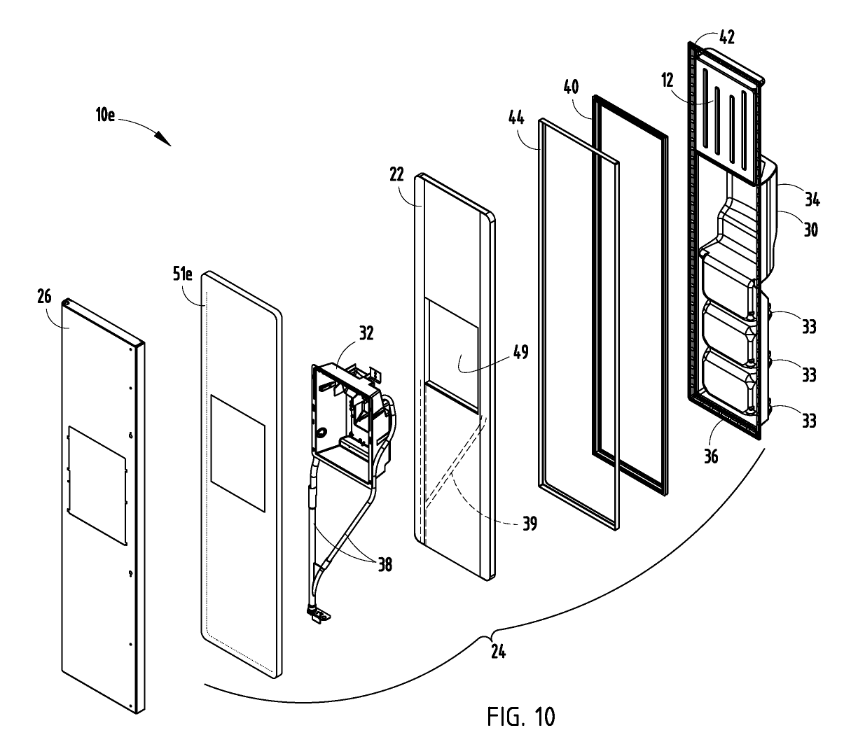

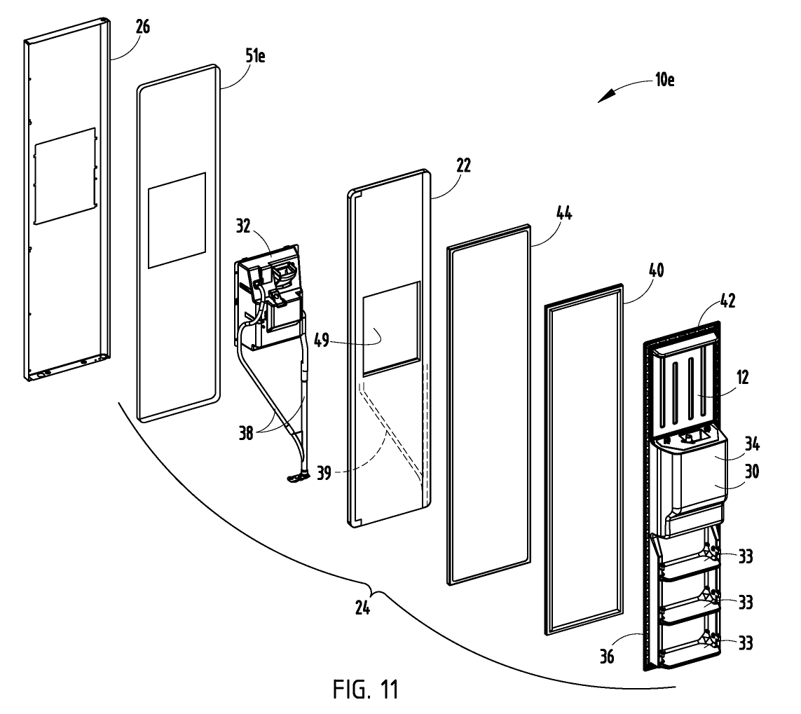

Referring now to the embodiment illustrated in FIGS. 10 and 11, yet another manner of assembling an appliance door 10e includes inserting a release agent or film 51e against the mold surface of the second forming mold 18 (FIGS. 1A-1C). The first and second forming molds 16, 18 are then closed and insulative material 22 is inserted into the cavity 20. The insulative material 22 conforms to the shape of the inner door liner 12. The inner door liner 12 and insulative material 22 are then withdrawn from the mold as a single frameless unit. The film 51e may be polyethylene or similar material. The film 51e can also be used as a moisture barrier. A component, such as the ice machine 32 shown, is inserted into the aperture 49 in the insulative material 22. The utility lines 38 may be encased in the insulative material 22, or may extend through channels 39 formed to receive the utility lines 38. The exterior skin 26, gasket 40, and door flange 44 are then press-fitted or otherwise fastened together about the periphery of the appliance door 10e. The insulative material 22, when assembled with the inner liner 12, decorative exterior skin 26 and flange 44, provides the structural rigidity for the appliance door 10e.

It is contemplated that pockets could be made in the insulative material 22 to accommodate removable insulation panels, such as those disclosed in U.S. patent application Ser. No. 12/466,398, entitled “VACUUM INSULATION PANELS APPLIED TO OR AS A FEATURE MODULE,” filed on May 15, 2009, the entire disclosure of which is hereby incorporated by reference, or storage compartments, such as those disclosed in U.S. patent application Ser. No. 12/402,608, entitled “PLENUM ON FRONT OF REFRIGERATOR/FREEZER DOOR,” filed on Mar. 12, 2009, the entire disclosure of which is hereby incorporated herein by reference, as well as removable modules or components, etc., such as those disclosed in U.S. patent application Ser. No. 12/402,559, entitled “VACUUM FOOD PRESERVATION SYSTEM,” filed on Mar. 12, 2009; U.S. patent application Ser. No. 12/402,747, entitled “CHILLING AND THAWING MODULAR APPLIANCE SYSTEM,” filed on Mar. 12, 2009; and U.S. patent application Ser. No. 12/402,731, entitled “MODULAR DOOR MOUNTED CLIMATE CONTROLLED MEDICINE COMPARTMENT,” filed on Mar. 12, 2009, the entire disclosures of which are hereby incorporated herein by reference. The decorative exterior skin 26 may then be assembled over the base door 24 to provide aesthetic variation in shape, color, finish, or type of material for door 10e.

FIGS. 12-17 illustrate one embodiment of the assembled appliance door 10. The appliance door 10 includes first and second brackets 53, 55 (FIG. 12) that are designed to secure a handle (not shown) to the door 10. Tabs 56 are also disposed along the door edge for connection of a trim piece (not shown). The interior of the door 10 has the shelves 33 disposed at the bottom of the door 10, however, it is contemplated the shelves 33 and any components (such as the ice machine 32) could be arranged in various manners or styles, as desired by the end user. Pin receivers 57 are designed to receive pivot pins about which the door 10 can rotate between open and closed positions after installation.

The appliance door 10 discussed above is designed for use with a variety of decorative skins 26. Accordingly, it is contemplated that a single base door 24 may be used across a breadth of appliances or models with the decorative outer skin 26 being the only changed item.

The decorative outer skin 26 may have a variety of constructions and is adapted to receive a variety of components. In addition, the base door 24 may be connected with, for example, the decorative outer skin 26 by press-fitting, and later have the decorative outer skin 26 removed and have a different decorative outer skin 26 secured over the base door 24 by end caps 64 that extend over the top and bottom edges 66, 68 of the inner door liner 12 to hold the exterior skin 26 in place, as discussed in further detail below.

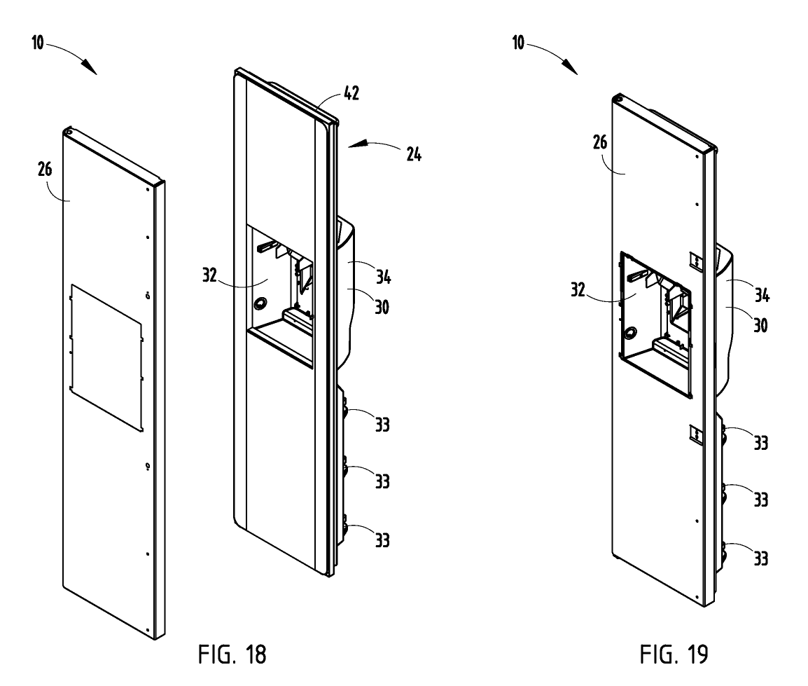

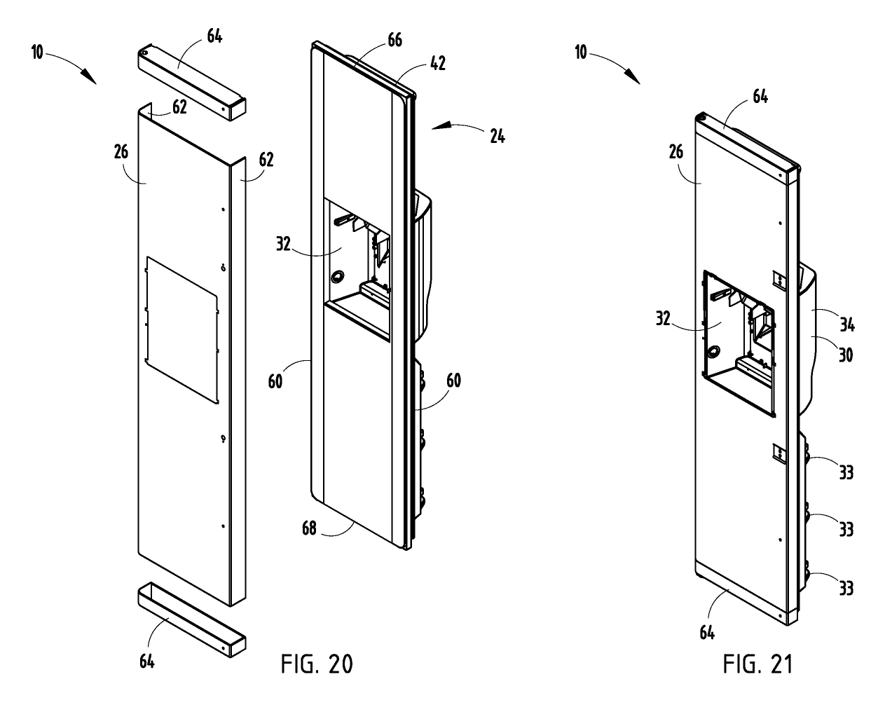

Referring now to FIGS. 18-21, in each of the aforementioned embodiments, it is conceivable that the exterior skin 26 may be press-fitted to the inner door liner 12, such as shown in FIGS. 18 and 19, or may be wrapped around side edges 60 of the inner door liner 12 as shown in FIGS. 20 and 21. End walls 62 of the exterior skin 26 cover the side edges 60 and abut the inner door liner 12. In the event that the exterior skin 26 is wrapped around side edges 60 of the inner door liner 12, then end caps 64 are situated over top and bottom edges 66, 68 of the inner door liner 12 to hold the exterior skin 26 in place. The decorative outer skin 26 can also be permanently bonded adhesively or by other mechanical means such as clips or screws.

The above description is considered that of the illustrated embodiments only. Modifications of the invention will occur to those skilled in the art and to those who make or use the invention. Therefore, it is understood that the embodiments shown in the drawings and described above is merely for illustrative purposes and not intended to limit the scope of the invention, which is defined by the following claims as interpreted according to the principles of patent law, including the Doctrine of Equivalents.

The invention claimed is:

1. A method of making an appliance door, the method comprising:
inserting a door pan into a fixture having first and second forming molds;
placing an inner door liner over the door pan;
pressing the first and second forming molds together;
forming a mold cavity between the door pan and the inner door liner;
injecting an insulative material into the mold cavity defined by the space between the door pan and the inner door liner;
securing the inner door liner to the door pan to form a base door; and
extending a removable decorative exterior skin over the base door.

2. The method of claim 1, further comprising:
placing a gasket assembly on the door pan.

3. The method of claim 1, wherein the step of injecting insulative material further comprises:
injecting an expandable polyurethane material.

4. The method of claim 1, wherein the step of extending a decorative exterior skin further comprises:
press-fitting the decorative skin over the door pan.

5. The method of claim 1, wherein the step of securing a decorative skin further comprises:
forming the decorative skin with first and second end walls that wrap around the base door.

6. The method of claim 5, further comprising:
covering a top end and a bottom end of the base door with outer end caps.

7. A method of making an appliance door, the method comprising:
inserting a film into a fixture having first and second forming molds;
placing an inner door liner over the film;
pressing the first and second forming molds together;
forming a mold cavity between the film and the inner door liner;
injecting an insulative material into the mold cavity defined by the space between the film and the inner door liner;
securing the inner door liner with a frame to form a base door; and
extending a removable decorative exterior skin over the base door.

8. The method of claim 7, further comprising:
placing a gasket assembly on the frame.

9. The method of claim 7, wherein the step of injecting insulative material further comprises:
injecting an expandable polyurethane material.

10. The method of claim 7, wherein the step of extending a decorative exterior skin further comprises:
fastening the decorative skin to the frame.

11. The method of claim 7, wherein the step of securing a decorative skin further comprises:
forming the decorative skin with first and second side walls that wrap around the base door.

12. The method of claim 11, further comprising:
covering a top end and a bottom end of the base door with outer end caps.

13. A method of making an appliance door, the method comprising:
inserting a support frame into a fixture having first and second forming molds;
inserting utility lines into the fixture;
pressing the first and second forming molds together;
injecting an insulative material between the first and second forming molds in contact with the support frame;
setting the injected insulative material;
securing an inner door liner to the insulative material and support frame to form a base door; and
removably securing a decorative exterior skin over the base door.

14. The method of claim 13, further comprising:
placing a gasket assembly adjacent the inner door liner and the exterior skin.

15. The method of claim 13, further comprising:
extending a door flange over the gasket that secures the gasket in position around a periphery of the appliance door.

16. The method of claim 13, wherein the step of inserting a support frame further comprises:
inserting a support frame having tubular support members.

17. The method of claim 13, wherein the step of inserting a support frame further comprises:
inserting a support frame having a single support member extending longitudinally through a central portion of the door.

18. The method of claim 13, wherein the step of inserting a support frame further comprises:
inserting a support frame made from rigid plastic.

19. The method of claim 13, wherein the step of inserting a support frame further comprises:
inserting a support frame formed from a single piece of stamped metal.

20. The method of claim 13, wherein the step of extending a decorative exterior skin further comprises:
fastening the decorative skin onto the base door.

21. The method of claim 13, wherein the step of securing a decorative skin further comprises:
forming the decorative skin with first and second side flanges that wrap around the base door.

22. The method of claim 20, further comprising:
covering a top end and a bottom end of the base door with outer end caps.

23. The method of claim 13, further comprising:
inserting a block into the fixture before the first and second forming molds are pressed together that forms an aperture in the insulative material for receiving a component.

24. The method of claim 13, further comprising:
cutting an aperture from the base door before the decorative exterior skin is removably secured over the base door.
